(19) United States
(12) Patent Application Publication
(10) Pub. No.: US 2026/0154976 A1
(43) Pub. Date: Jun. 4, 2026

(54) COMPUTER-IMPLEMENTED TRANSFECTION ANALYSIS USING A VECTOR FIELD MAP

(71) Applicant: Carl Zeiss Microscopy GmbH, Jena (DE)

(72) Inventors: Manuel AMTHOR, Jena (DE); Daniel HAASE, Zoellnitz (DE)

(73) Assignee: Carl Zeiss Microscopy GmbH, Jena (DE)

(21) Appl. No.: 19/407,821

(22) Filed: Dec. 3, 2025

(30) Foreign Application Priority Data
Dec. 4, 2024 (DE) 102024136011.9
Oct. 8, 2025 (DE) 102025141074.7

(51) Int. Cl. G06V 20/69; G06T 7/00; G06T 7/12; G06V 10/75

(52) U.S. Cl. CPC G06V 20/695; G06T 7/0012; G06T 7/12; G06V 10/751; G06T 2207/10056; G06T 2207/10064; G06T 2207/30024

(57) ABSTRACT

Various examples of the disclosure concern a transfection analysis for cells that are imaged in a microscope image. Techniques are disclosed for the purpose of determining a cell-specific transfection level or a scene-global transfection level using a vector field map.

### RELATED APPLICATION DATA

The present application claims priority from German Patent Application No. DE 102024136011.9, filed Dec. 4, 2024 and DE 102025141074.7, filed Oct. 8, 2025, which are hereby fully incorporated herein by reference.

### FIELD OF THE INVENTION

Various examples of the disclosure concern transfection analysis on the basis of one or more microscope images. Various examples concern in particular computer-implemented automation of transfection analysis, involving the use of a vector field map.

### BACKGROUND OF THE INVENTION

One field of application of microscopy lies in the examination of cells. In particular, microscope images that image a scene with cells may be evaluated in order to determine the transfection level of cells. In order to fluorescently label a specific protein of the cells, the associated gene is coupled to the gene sequence of a fluorescent protein (genetic fusion). Should the modified gene be introduced into the cell (transfection), the cell expresses the fusion protein comprising target protein and fluorophore. For example, whether or not the protein is within the cell can then be rendered visible by means of fluorescence imaging. Whether or not transfection is present can be determined for a single cell.

In reference implementations, applicable microscope images are evaluated manually, and hence this is time-consuming and subjective.

Automated techniques for transfection analysis are also known, for instance from CN116609311 A or CN118782156 A. Such techniques are sometimes inaccurate or not very robust. For example, the detection of image regions that have a fluorescence signal is not always easy, because the fluorescence signal may also have interference signal components. Applying an appropriate filter with a threshold may also be inaccurate depending on the specific imaging modality.

### SUMMARY OF THE INVENTION

Thus, there is a need for improved transfection analysis techniques. In particular, there is a need for automated techniques that allow the transfection level for cells to be determined in a robust manner and by automation on the basis of microscope images.

A computer-implemented method comprises obtaining one or more microscope images. The one or more microscope images image a scene with cells. The computer implemented method comprises performing a first image evaluation. The first image evaluation is based on at least one of the one or more microscope images. A vector field map is obtained on the basis of the first image evaluation. The vector field map maps each of multiple image regions onto an applicable reference image region. The reference image regions are associated with different cells. The method also comprises performing a second image evaluation. The second image evaluation is based on at least one of the one or more microscope images and the vector field map and is used to obtain cell-specific result data for the scene. The cell-specific result data indicate a cell-specific transfection level for a fluorescent dye-based transfection of the cells.

An electronic data processing device is also disclosed. An electronic data processing device of this kind is designed to carry out such a computer-implemented method described above.

A system is also disclosed that comprises such an electronic data processing device together with a microscope, which is designed to capture the microscope images.

The features set out above and features described below can be used not only in the applicable combinations that are explicitly set out, but also in other combinations or in isolation, without departing from the scope of protection of the present invention.

### BRIEF DESCRIPTION OF THE DRAWINGS

FIG. 1 is a flowchart for an illustrative method for performing a transfection analysis using a vector field map.

FIG. 2 illustrates details of a first and a second image evaluation to determine a vector field map and then a transfection level on the basis of the vector field map.

FIG. 3, FIG. 4, FIG. 5 and FIG. 6 show illustrative vector field maps.

FIG. 7 and FIG. 8 illustrate boundary conditions of a vector field map according to various examples.

FIG. 9 schematically shows an instance segmentation map that can be used to determine a vector field map, for example during training or inference.

FIG. 10 is a flowchart for an illustrative method for determining a transfection level on the basis of a vector field map.

FIG. 11 and FIG. 12 illustrate the techniques to ascertain a threshold value for determining whether or not a specific cell is transfected.

FIG. 13 schematically illustrates an electronic data processing device according to various examples.

FIG. 14 schematically illustrates a data processing sequence for a transfection analysis by means of a vector field map according to various examples.

FIG. 15 shows an illustrative phase contrast microscope image.

FIG. 16 illustrates a cell center map and the cell center map overlaid on the phase contrast microscope image from FIG. 15.

FIG. 17 schematically illustrates a vector field map overlaid on the phase contrast microscope image from FIG. 15.

FIG. 18 schematically illustrates the vector field map overlaid on a fluorescence microscope image according to various examples.

FIG. 19 schematically illustrates the aggregation of pixel values of the fluorescence microscope image that indicate a fluorescence signal at cell centers by means of a vector field map according to various examples.

FIG. 20 illustrates a cell-specific transfection level according to various examples.

FIG. 21 is a flowchart for an illustrative method.

FIG. 22 is a flowchart for an illustrative method.

### DETAILED DESCRIPTION OF THE INVENTION

The above-described properties, features and advantages of this invention and the way in which they are achieved will become clearer and more clearly understood in the context of the following description of the exemplary embodiments, which are explained in greater detail with regard to the drawings.

The present invention is explained in greater detail below on the basis of preferred embodiments with reference to the drawings. In the figures, identical reference signs designate identical or similar elements. The figures are schematic representations of various embodiments of the invention. Elements illustrated in the figures are not necessarily illustrated as true to scale. Rather, the various elements illustrated in the figures are rendered in such a way that their function and general purpose become comprehensible to a person skilled in the art. Connections and couplings between functional units and elements illustrated in the figures can also be implemented as an indirect connection or coupling. A connection or coupling can be implemented in a wired or wireless manner. Functional units can be implemented as hardware, software or a combination of hardware and software.

Techniques concerning the image evaluation of one or more microscope images are described below. The microscope images are evaluated in order to provide a transfection analysis. This means that a transfection level is determined. The transfection level can be determined generally for individual cells in a scene or in scene-global fashion for the scene. It would be conceivable for a local transfection level for each cell in the scene to be determined first; an appropriate aggregation for the scene can then be performed in order to determine the global transfection level on the basis of the local transfection level.

This may be a binary transfection level (e.g. transfection “yes/no” classification) if the transfection level is determined for individual cells; however, it would also be possible for such a cell-specific transfection level to indicate a probability for the expression of the protein for a specific cell. For example, there is determination as to whether or not the cell belonging to the cell nucleus expresses the dye or whether errors have arisen. A regression on an expression efficiency value (e.g. between 0 and 100) is also possible.

A global transfection level may also be determined. Such a global transfection level may indicate the proportion of the transfected cells from among all cells in a scene.

The transfection analysis uses one or more microscope images. In principle, microscope images can be captured using different imaging modalities. This thus means that microscope images with different contrasts may be used in the various techniques described herein for determining a transfection level. In particular, multichannel recordings may be captured, the latter comprising multiple microscope images that image the scene with cells using different contrasts. For example, specific contrasts and non-specific contrasts may be combined in a multichannel recording.

A specific contrast labels certain cell structures in a specific manner. For example, use can be made of a specific fluorescence contrast or a specific contrast without fluorescing label. Use can be made of one or more fluorescence contrasts that are of assistance specifically in transfection analysis. In particular, these are fluorescence contrasts that may be used specifically for observing transfected cells. A specific fluorescence contrast, which is referred to as transfection fluorescence contrast below, is used to render the fusion protein visible.

H&E can be used to visualize the general morphology of the cells. DAPI (4′,6-diamidino-2-phenylindole) is a fluorescence contrast that labels the cell nucleus. Phalloidin is a fluorescence contrast that labels the actin filament network within a cell.

A non-specific contrast would be e.g. a phase contrast or a bright field contrast. For example, the non-specific contrast could be a phase-like contrast. A phase-like contrast can be e.g. a phase contrast. Examples include e.g. a Zernike phase contrast, a Normarski phase contrast. In this case, specific optical elements are used in the beam path of the light, e.g. a phase ring in the objective and a ring stop in the condenser lens. Interference between the background and object light can be rendered visible in this way. The image contrast can be increased by using a phase contrast. That means that the cell structures are visible particularly well. Cells are phase objects that do not cause any reduction, or any significant reduction, in the amplitude of the light when the latter passes through the cell sample, and so the phase contrast is preferred for rendering the phase shift visible. However, a digital phase contrast can also be used as phase-like contrast. A plurality of images are recorded here, and are then computationally combined to form a single phase contrast image. Therefore, such techniques may be referred to as digital phase contrast. The phase contrast is obtained by digital post-processing of the intensity images recorded. Examples include the transport of intensity equation (TIE) and the differential phase contrast (DPC). TIE is described in: Streibl, Norbert. “Phase imaging by the transport equation of intensity.” Optics communications 49.1 (1984): 6-10. DPC is described in: Mehta, Shalin B., and Colin J R Sheppard. “Quantitative phase-gradient imaging at high resolution with asymmetric illumination-based differential phase contrast.” Optics letters 34.13 (2009): 1924-1926. To record a TIE data set, the sample is displaced along the optical axis (z-direction), i.e. displaced axially, and what is known as a z-stack, consisting of at least two images, is recorded. The data are then combined by calculation, whereby a phase contrast image is obtained. For this purpose, a diffusion-type partial differential equation is solved. In DPC, the sample is illuminated from at least two different directions (oblique illumination) while the sample remains at a fixed z-position. All types of segmented sources are possible sources for the oblique illumination; examples include segmented diodes, light-emitting diode arrays, digital micromirror devices (DMDs), liquid crystal displays (LCDs or SLMs) or variable condenser stops. The data recorded are subsequently converted into a phase contrast image by solving a deconvolution problem. Combinations of TIE and DPC would also be conceivable, e.g. as described in European Patent Application 24 184 623.7 dated 26 Jun. 2024. The use of a digital phase contrast (as opposed to a hardware-based phase contrast) has the advantage that there is no need for complex insertion or removal of objects into/from the beam path of the light when capturing the digital phase contrast. Rather, the illumination can be varied in a targeted manner, for example by means of a switchable light-emitting diode array arranged in the illumination pupil plane. This can be implemented quickly and easily.

The non-specific contrast types thus include “label-free” contrasts such as phase contrast, DIC contrast or TIE contrast, which enable an observation of cell structures without specific labels. Alternatively, stains such as H&E may be used in order to specifically label certain cell structures. A further option lies in the use of fluorescent stains, such as DAPI, in order to fluorescently label specific cell constituents. Autofluorescence may also be used to locate cells without additional labels.

It may also be the case that multiple channels are used in order to show different fluorescent dyes. In this case, it is possible to make separate predictions for each channel or an overall prediction for all channels.

One example even sees the use of only one channel or a single contrast, which simultaneously enables the localization of all cells and the determination of the transfection level. In this case, cells may be located by way of autofluorescence, for example.

While solutions are described for 2-D image data in particular, the techniques described herein can also be used for 3-D image data (for instance from light-sheet microscopy). For this purpose, for example 2-D sectional images for one or more surfaces (e.g. planes, for example stacked planes) can be extracted from the 3-D image data and then processed using the 2-D techniques described herein. For example, the first image evaluation and the second image evaluation can be applied to each of the 2-D sectional images. In this way, cell-specific result data are obtained for each 2-D sectional image. Subsequently, it is then possible to merge these cell-specific result data obtained for the various 2-D sectional images in order to thereby obtain 3-D cell-specific result data in a reference coordinate system associated with an imaging volume of the 3-D image data. For example, when merging the cell-specific result data, a consolidation can be carried out if cell-specific result data were determined for the same cell for different 2-D sectional images. This may be the case when applicable surfaces are arranged close to each other or even so as to intersect in the imaging volume. In another example, the vector field maps intended for the various sectional images can also be combined with one another. In this way, a 3-D vector field map is thus obtained from an imaging volume.

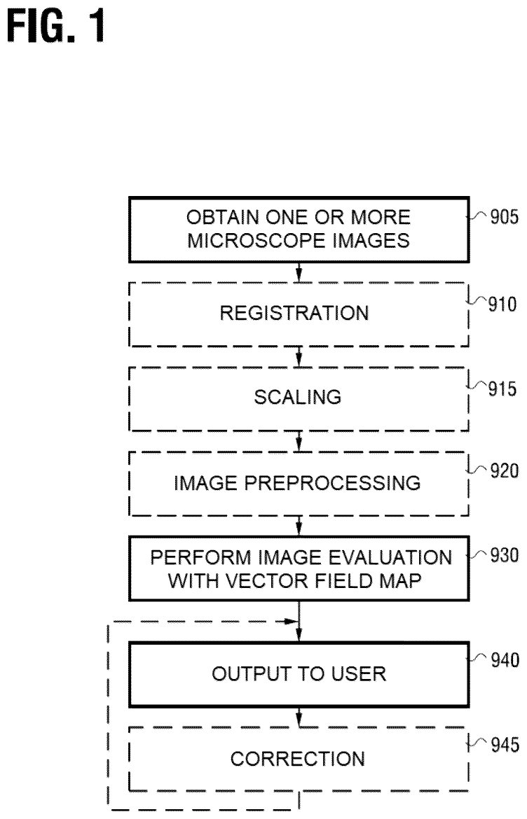

FIG. 1 shows a flowchart for an illustrative method. The method from FIG. 1 can be carried out by an electronic data processing device, for example. The electronic data processing device may comprise a processor unit and a memory. The processor is capable of loading program code from the memory and executing it. When the processor unit executes the program code, this has the effect that the processor carries out the method from FIG. 1.

Optional boxes are shown using dashed lines.

One or more microscope images are obtained in box 905. To this end, a microscope may, for example, be controlled in order to capture the applicable microscope images. The microscope images may be received from the microscope. The microscope images may also be loaded from a memory, for example from an image database.

If multiple microscope images are obtained, then these may jointly image a scene with cells. The multiple microscope images can image a cell sample. The multiple microscope images may be part of a joint multichannel recording. However, it would also be conceivable for the multiple microscope images to be captured in succession, for example according to individual staining cycles, in which certain cells are stained or destained or otherwise manipulated.

The assumption made below is that at least two microscope images are obtained in box 905: a first microscope image that is suitable for the detection of cells (this is referred to as the reference microscope image below) and a second microscope image that has the transfection fluorescence contrast (referred to as the fluorescence microscope image below).

The reference microscope image preferably shows all cells with a high contrast ratio vis-à-vis the background. Typically, a phase contrast, for example a digital phase contrast, may be used for the reference microscope image (phase contrast microscope image). In principle, the use of more than one reference microscope image would be conceivable, with the different reference microscope images having different contrasts in that case. For example, use could be made of a first reference microscope image with a bright field contrast and a second reference microscope image with a phase contrast.

The microscope images from box 905 are registered to one another in optional box 910. The multiple microscope images may be registered if use is made of multiple microscope images—for example captured entirely separately or as channels of a multichannel image. For example, the registration may be implemented in image-based fashion or else in point cloud-based fashion by way of localization results. In the point cloud-based registration, results from the image evaluation may be used to create point clouds that are subsequently used for registration purposes. For example, a first point cloud may be created on the basis of center-point detections for the cells in the first channel, while a second point cloud maps local maxima in the fluorescence channel. In that case, the registration may be implemented by applying an algorithm such as the iterative closest point algorithm in order to determine the relative positioning of the images in relation to each other.

However, it would also be conceivable for the microscope images from box 905 to have already been registered in advance and for corresponding registration parameters to already be available. Box 910 need not be executed in that case.

The microscope images may also be inherently registered to each other, i.e. the same pixels represent the same object points in the scene. For example, such inherent registration of the microscope images may be present in particular if the various microscope images are part of a multichannel recording. The imaging system of the microscope is typically subject to only minor changes between the capture of various microscope images of a multichannel recording, for example by virtue of a color filter being introduced into or removed from the beam path. Hence, corresponding microscope images are frequently already inherently registered to each other (for example if chromatic aberrations are small).

The microscope images may be optionally scaled in box 915. For example, scaling may be implemented such that the microscope images subsequently image the cells with a certain imaging scale. In other words, this thus means that the scaling may be implemented in such a way that the cells have a certain size in the microscope images (structural unit size). The size may be predefined. In particular, the structural unit size may correspond to a size of cells in reference microscope images used for the training of one or more machine-learned models that are subsequently used in the image evaluation. This is because the complexity of corresponding machine-learned models can be reduced in this way as the latter only expect cells with a certain imaged size. The training complexity for such machine-learned models may be reduced. The training data need not contain cells with different imaging scales but may be restricted to cells of the certain imaged size.

For example, the scaling in box 915 can be implemented manually. However, it would also be conceivable for the scaling in box 915 to be implemented by means of a machine-learned model. For example, a machine-learned model that performs an image-to-image transformation, i.e. outputs the rescaled image, could be used. However, use of a machine-learned model that outputs a scaling factor, i.e. performs an image-to-scalar transformation, would also be possible. The principles of an exemplary rescaling technique are described in: EP 4 053 805 A1. The applicable techniques are incorporated herein by cross-reference.

Optionally, in box 920, preprocessing—for example refinement or filtering—of one or more of the microscope images from box 905, which may have been rescaled, can take place. Thus, microscope images with a fluorescence contrast, in particular the transfection fluorescence contrast, may be refined in particular. For example, dirt may be removed. Dye residues, etc., which potentially cause a fluorescence signal, may be removed. In an alternative to that or in addition, a background correction may also be implemented, for example if the data have an offset. For example, a smoothing operation may be performed in box 920. One or more microscope images can undergo noise removal.

In box 920, an interference signal component of a fluorescence signal of the fluorescence microscope image can optionally be reduced or removed. This can be done on the basis of a cell mask map, for example. The cell mask map can be determined on the basis of the phase contrast microscope image, for example. Based on the cell mask map, the interference signal component can then be determined in regions outside of cells. This is based on the recognition that the interference signal component cannot be determined in a robust manner in regions of cells because not only the interference signal component but also the foreground signal component may be present there. Based on the determination of the interference signal component in regions outside of cells (these image regions are ascertained on the basis of the cell mask map), the interference signal component can then also be estimated in image regions within cells. In this way, an interference signal map can thus be determined and this interference signal map can be used to reduce or eliminate the interference signal component of the fluorescence signal. Such an interference signal component may typically have different parts, for example a background signal component (which typically only has small spatial frequency components); but it would also be conceivable for this interference signal component to have portions with higher spatial frequencies, for example due to dye accumulations, etc.

For example, in certain variants it would be conceivable for the sequence of box 915 to be swapped to under item 920. Preprocessing can be carried out on the images that have not yet been rescaled.

The one or more microscope images from box 905 undergo image evaluation or image processing in box 930. For example, a cell-specific transfection level can be determined.

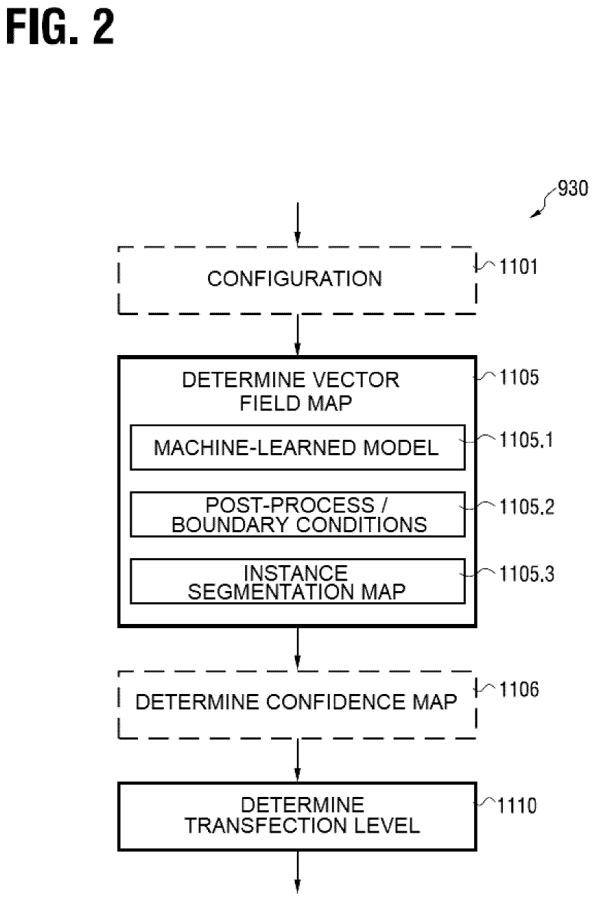

A vector field map that maps each of multiple image regions onto an applicable reference image region is used in box 930. In that case, different reference image regions are once again associated with different cells. Details relating to a possible implementation of box 930 are explained below with regard to FIG. 2.

Subsequently, a user interface may be controlled in box 940. In particular, a graphical user interface may be controlled. Information with regard to the cell-specific and/or scene-global transfection level may then be output. For example, the user interface could be controlled to output graphical information that is determined on the basis of at least one of the microscope images from box 905 and the result data from box 930.

In particular, cell-specific result data overlaid on the one or more microscope images may be output. For example, given availability of a cell-specific transfection level, each of the transfected cells could be highlighted in a microscope image in a specific manner; in an alternative to that or in addition, each of the non-transfected cells could be highlighted in a microscope image in a different manner.

It is conceivable for box 940 to involve an instance segmentation mask being determined for the cells. In that case, it is for example possible for the cell-specific transfection level to be output in box 940 together with mask regions that label various cells. This is a particularly easily interpretable representation. For example, the vector field map can be converted into an instance segmentation map. The instance segmentation map can then be displayed to a user. Such conversion of the vector field map into the instance segmentation map can be performed using e.g. a watershed or Dijkstra's algorithm (where “mountains” are defined by the vector lengths). For example, each vector can be assigned to a specific cell center and the pixels of the microscope image can be colored according to this assignment. For example, each cell center could have a specific color. The resulting masks can be post-processed where applicable. For example, morphological operations can be used to smooth them. Small holes can be closed.

One example is representation of the cells as colored points. One point (or other label) per cell may be used to visualize the transfection results. For example, the position of the point may be at the cell center, centroid or nucleus. In other words, a microscope image (for example the fluorescence microscope image) overlaid with a cell-specific graphical indicator of the cell-specific transfection level can thus be displayed.

Another option is representation of the results by means of colors. For example, green, orange and red may be used to indicate the classes of “transfected”, “overexpressed” and “non-transfected”.

It would also be conceivable to indicate a sorting of the cells according to probability of transfection, for example overlaid on the respective microscope image.

A few examples of how, cell-specifically, a representation of the cell-specific transfection level may be performed were described above. It is also possible, in an alternative to the aforementioned or in addition, for the scene-global transfection level to be output, for example next to an applicable microscope image. For example, the following could thus be output: “79% of all cells successfully transfected”.

Another option would be to determine a distribution of pixel values of image pixels that represent transfected cells. Another distribution of pixel values of image pixels that represent non-transfected cells can also be generated. Applicable distributions could then be output to a user.

A correction of the result data could optionally be implemented in box 945. For example, a user could label certain cells, which are labelled as transfected, as being in fact non-transfected. In that case, it would be possible for the image output in box 940 to be adapted (dashed arrow).

Another option for correcting the result data 945 concerns obtaining a user input concerning the decision boundary for differentiating between transfected and non-transfected cells. For example, there is a description above of techniques that involve a threshold value that regulates whether a transfected cell or a non-transfected cell is present being found in a specific manner. It would be conceivable for the user to be able to change this threshold value in box 945, for example by means of a slider, and then interactively see the influence of such a change on the classification result in the image. For example, it is possible to indicate the influence that changing the threshold value has on the classification of cells as transfected or non-transfected (or on other or further classification criteria with regard to transfection). In other words, it is thus possible to provide an ongoing human-machine interaction. This ongoing human-machine interaction may firstly comprise obtaining the user input concerning setting the decision boundary for the classification. Then again, the ongoing human-machine interaction may also comprise the output of an influence of the user input on the classification result to the user. This is advantageous in that the user is able to interactively “scan” the decision boundary and, for example, identify regions of particularly high sensitivity. This allows better definition of the decision boundary, in particular according to the underlying one. In other words, it is thus possible to provide an ongoing human-machine interaction. This ongoing human-machine interaction may firstly comprise obtaining the user input concerning setting the decision boundary for the classification. Then again, the ongoing human-machine interaction may also comprise the output of an influence of the user input on the classification result to the user. Such a procedure is advantageous in that the user is able to interactively “scan” the decision boundary and, for example, identify regions of particularly high sensitivity. These are regions in which a small change to the decision boundary has a particularly large influence on the classification result. Knowledge of such regions of high sensitivity often helps in order to obtain good results for the classification.

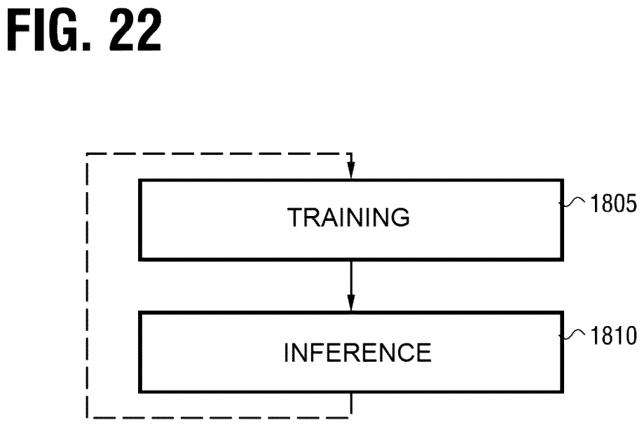

Further ground truths or training data may be collected on the basis of such a user input. Based on such ground truths, there could then be renewed training of one or more machine-learned models, which are used in box 930 (details are also explained later with regard to FIG. 22).

Various variations of the method from FIG. 1 are conceivable. For example, the sequence of the various boxes may be varied. For example, it would thus be conceivable for box 920 to be executed before box 915. It would also be conceivable for multiple iterations of box 930 to be performed, for example for multiple sets of one or more microscope images or by virtue of different regions of microscope images being processed separately. In this way, an individual evaluation may be obtained for different areas of a sample. For example, that might allow the determination of a scene-global transfection level for different wells in a multiwell plate. Certain parameters with regard to the image evaluation in box 930 could be synchronized between the various instances of box 330. Examples here concern in particular decision criteria for distinguishing between different values of the transfection level. In this way, it would be possible to ensure that the same decision criteria are applied for the assessment of different areas of the sample such that a consistent evaluation is rendered possible across the different areas of the sample.

Details with regard to the image evaluation for determining the transfection level in box 930 are described below.

FIG. 2 is a flowchart that illustrates a method for determining a vector field map and using the vector field map to determine a transfection level. FIG. 2 illustrates a method for implementing box 930 from FIG. 1.

The method from FIG. 2 determines a cell-specific transfection level by way of illustration. This preferably involves two microscope images being evaluated, a reference microscope image and a fluorescence microscope image. A first microscope image enables the determination of a vector field map in box 1105, while a second microscope image displays the fluorescent dye on which the transfection is based, i.e. which should be expressed, and this second image is used to determine the transfection level in box 1110. Thus, the reference microscope image from box 905 may be used in box 1105, and the fluorescence microscope image with transfection fluorescence contrast may be used in box 1110. This is explained in detail below.

The method starts with box 1101. In box 1101, the image evaluation is optionally configured in order to determine the vector field map in box 1105 and/or the image evaluation is configured in order to determine the transfection level in box 1110. Alternatively or in addition, a possible image preprocessing (cf. box 920 in FIG. 1, which can also be carried out according to box 1101) could also be configured. The configuration of box 1110 could involve, for example, the way in which the vector field map is used to determine the transfection level being set.

An applicable setting can be implemented depending on a type of the one or more microscope images. For example, an applicable configuration could be implemented depending on the contrast of the reference microscope image and/or the contrast of the fluorescence microscope image. For example, the fluorescent dye used could be taken into consideration. For example, it would be possible to take into consideration which cell structures are stained by the fluorescent dye. For example, it would be possible to identify whether the cell membrane is stained or another structure of the cell. It would be possible to check whether there is a specific or non-specific contrast. For example, if the cell membrane is not stained, a model that provides a certain tolerance range or “safety margin” at the edge of each cell could be selected for determining the vector field map in box 1105. Such techniques are based on the recognition that, when staining cell structures other than the membrane, it is incidentally unnecessary to detect the exact fluorescence signal in the region of the cell wall in order to accurately determine the transfection level; therefore, it may be desirable to provide a certain tolerance for the formation of the vector field map there.

A first image evaluation is carried out in box 1105 on the basis of at least one microscope image; a vector field map is determined in the process. The vector field map maps different image regions—for example pixels or superpixels—onto an applicable reference image region. In that case, different reference image regions are associated with different cells. A superpixel is an image region in a microscope image that contains a group of adjacent pixels. This group of pixels is treated as a unit and may be represented by a single vector in the vector field map.

The vector field map may comprise two or three output channels, depending on whether this relates to 2-D or 3-D image data. For example, the vector field map may be represented as x-channel and y-channel in Cartesian coordinates or as angle channel and distance channel in polar coordinates. The vector field map may be defined for individual pixels in the microscope images. In place of a vector field map defined for individual pixels, the method may also be applied to larger image regions, i.e. image regions comprising multiple image pixels. For example, regularly shaped regions such as squares or rectangles may be used as image regions. So-called “superpixels” may also be used.

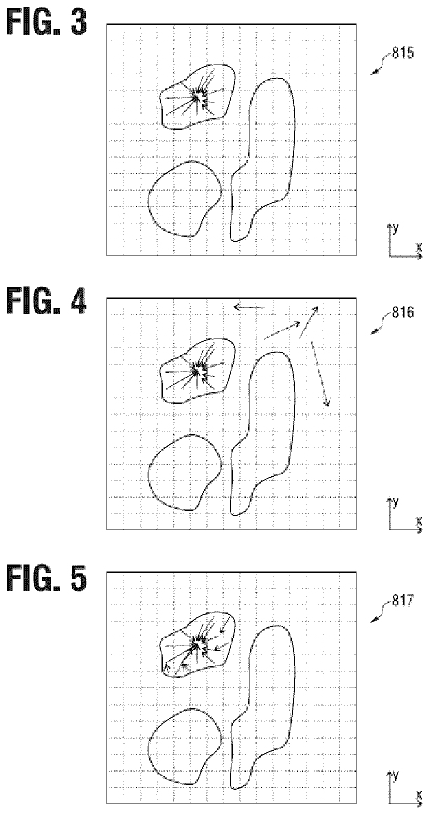

A few variants for the vector field map are illustrated below. An illustrative vector field map 815 is shown in FIG. 3. The grid of the vector field map 815 is represented by means of the dotted lines. A vector is provided for each entry in the vector field map 815, and said vector maps the respective image region (for example pixels or superpixels) onto a reference image region; this is represented by means of the arrows for the top left cell. This thus means that all image regions belonging to a common cell are mapped onto the same reference image region. FIG. 4 shows another vector field map 816, which, in principle, corresponds to the vector field map 815. In the variant of the vector field map 816, image regions outside of cells are mapped onto random reference image regions (shown top right in FIG. 4). In another variant, it would be conceivable for image regions outside of cells not to have any mapping onto reference image regions. FIG. 5 shows another vector field map 816. This vector field map 816 also corresponds, in principle, to the vector field map 815 or the vector field map 816. In the variant of the vector field map 816, however, there are vector chains. This means that the end point of one vector is simultaneously the starting point of another vector. In other words, such a vector chain can thus map an image region onto a reference image region, this reference image region being represented by a further vector and also a further reference image region. FIG. 6 shows another vector field map 818 that is actually calculated. It is evident from FIG. 3 and FIG. 4 and FIG. 5 and in particular from FIG. 6 that a vector field does not directly assign image regions to the cells. Instead, for each image region (i.e. each pixel, for example), it indicates where the relevant cell center (or another unique anchor point) of the underlying cell lies. That is to say the vectors of two image regions of a cell should point to a common point, but these two image regions are not directly linked to each other in the vector field.

Referring again to FIG. 2: box 1105. There are, in principle, various options for determining a vector field map. Some algorithmic implementations are explained below. For example, a machine-learned model can be used to determine the vector field map in box 1105.1 in FIG. 2. Mapping pixels of the microscope image onto vectors in the vector field map may thus be implemented using a machine-learned model. Examples in this respect include CNN-based image-to-image networks, for example UNet. A further option lies in the use of transformer-based image-to-image networks, for example ViTMAE. Hybrid networks, for example VQGAN, may likewise be used. An advantage with regard to determining the vector field map by means of the machine-learned model is that the applicable machine-learned model need not operate on the basis of fluorescence contrasts. For example, a microscope image that is used as input for the machine-learned model in order to determine the vector field map may have a specific phase contrast—for example a digital phase contrast. This can enable particularly robust training of the machine-learned model, which is invariant vis-à-vis variations in the fluorescence contrast (for example on account of the use of different dyes for different transfection experiments). When using a machine-learned model to determine the vector field map in box 1105, the output from the machine-learned model may sometimes fail to meet certain boundary conditions or properties. Therefore, it may be desirable in different variants for determination of the vector field map by means of a machine-learned model (box 1105.1) to result in the output from the machine-learned model (box 3105.2) then being post-processed. As optional post-processing in box 1105.2, for example after the application of a machine-learned model to determine the vector field map, the predicted reference image regions can be combined or consolidated to eliminate any variances in the location assignment. A consistency check can be performed. For example, all reference image regions within a certain radius may be combined to form a reference image region, and the respective vectors may be corrected accordingly. However, other neighborhood relationships may also be taken into consideration for such a consolidation. Another post-processing technique in box 1105.2 involves eliminating vector chains. For example, vector chains could be replaced with corresponding end-to-end vectors.

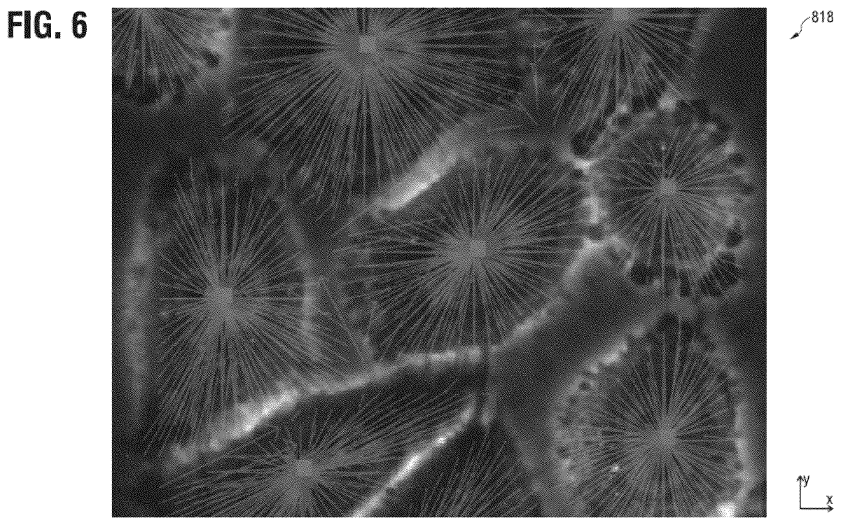

In box 1105.2, therefore, one or more boundary conditions can generally be taken into consideration. For example, it is possible to take into consideration at least one boundary condition that comprises a specification for a spatial distance between reference image regions assigned to adjacent vectors in the vector field map. For example, a value gradient could be defined for the entire microscope image. For example, this value gradient could set values from −500 to +500 for an image width of 1000 pixels. In that case, for each pixel or each image region that is mapped onto a reference image region by the vector field map, an offset from the gradient value associated with the respective reference image region can be predicted. Only a single offset is permitted for each cell. Such a scenario is described in FIG. 7. FIG. 7 uses the crosses to show the lengths 2610 of various vectors representing image regions at different x-positions within a fluorescence microscope image. FIG. 7 only shows a subregion along the x-axis that is within a single cell. FIG. 7 shows lower and upper bounds 2611, 2612, which are obtained as linear value gradients with an offset. The lower and upper bounds define a tolerance range for the change or difference in the lengths of adjacent vectors—and thus the spatial distance between the reference image regions assigned to adjacent vectors in the vector field map. Three vectors—marked by the dotted circles—determined, for example, by a machine-learned model in box 1105.1, are outside of the tolerance range and thus violate the required boundary condition. These vectors can be corrected in box 1105.2, for example by moving them to the nearest bound 2611, 2612 or by deleting them and replacing them with an interpolation on the basis of adjacent vectors.

Another boundary condition that can be used with regard to a consistency check on a vector field map in box 1105.2 is shown with regard to FIG. 8. FIG. 8 uses the filled circle to show a prediction for a cell center. In addition, at a certain distance around the position of the cell center, the dashed line shows a tolerance range 2621, which in turn defines a boundary condition for the end points of the vectors. A few vectors in a vector field map are also shown. Of these vectors, five vectors point to reference image regions that are sufficiently close to the cell center, that is to say in particular within the circle 2621. Only one of the vectors ends outside of the circle 2621 and could be corrected in a consolidation. In general, a boundary condition taken into consideration with regard to determining the vector field map may thus comprise a specification for the distance between the reference image region to which the vectors point and cell centers shown in a cell center map. Different actions can be applied to the vector (marked by the small dotted circle) that maps onto a reference image region outside of the tolerance range 2621: for example, this vector could be deleted, meaning that vector field maps at the applicable image region that forms the origin of the vector are zero. It would also be conceivable for the reference image region, that is to say the end point of the vector, to be corrected, for example on the basis of an interpolation of the adjacent vectors. In this specific case, the vector could thus be “drawn longer”. More generally, a boundary condition could either prohibit or allow vectors in the vector field map, depending on the subregion of a cell in which the respective vector starts and/or ends. If this concept is applied to FIG. 8, the result is: vectors ending in reference image regions that are further away from a cell center than a particular specified distance are prohibited. Alternatively or in addition, it would also be conceivable, for example, for vectors starting in cell edge regions, for example close to the cell membrane, to be prohibited. As already explained above, such a boundary condition could be either activated or deactivated, depending on the fluorescence contrast used by the fluorescence microscope image. In other words, a boundary condition can thus be selected according to a contrast type of the fluorescence microscope images or reference microscope images used. In another variant, it would be possible for certain boundary conditions—for example the boundary condition discussed with regard to FIG. 8—not to be taken into consideration for vectors that start in a cell edge region. Cell edge regions can be determined on the basis of a cell mask map.

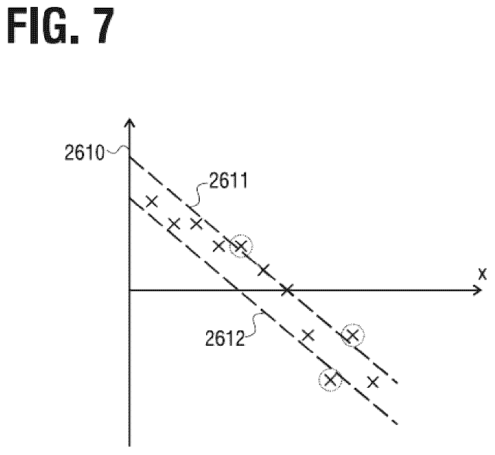

There is a description above, with regard to FIG. 2: box 1105.1 and box 1105.2 and FIG. 7 and FIG. 8, of techniques that involve the vector field map being determined first by means of a machine-learned model (box 1105.1) and then a post-processing being carried out to enforce boundary conditions (box 1105.2). In other variants, the vector field map could also be determined directly on the basis of applicable boundary conditions. This is shown in FIG. 2: box 1105.3. Box 1105.3 determines an instance segmentation map for the cells in the cell sample, for example by means of an applicable machine-learned model. This is illustrated in greater detail in FIG. 9, in that case instance segmentation map 812. Within a cell, the lengths of the vectors are then set according to an applicable value gradient 2605. This value gradient can be predicted as an offset from an image-global value gradient (not shown) or defined individually for each cell from the outset. More generally, such a value gradient 2605, as shown for example in FIG. 7, thus yields a boundary condition that comprises a specification for the length difference between adjacent vectors in the vector field map and is used for determining the vector field map. The length difference between adjacent vectors within a cell must only diverge by a single pixel.

So, while FIG. 9 shows inherent consideration of such a boundary condition for determining the vector field map, there is a description above, with regard to FIG. 7 and FIG. 8, of techniques that involve the boundary conditions being taken into consideration retrospectively after the vector field map has been determined, for example to allow correction of the vector field map in the event of non-compliance with the boundary condition. These are fundamentally different approaches to implementing box 1105 in FIG. 2 that were described above with regard to box 1105.1 and box 1105.3.

Referring again to FIG. 2: it would be conceivable for multiple vector field maps to be determined in box 1105. For example, if multiple reference microscope images are available, multiple vector field maps can be determined on the basis of different instances of these reference microscope images. Such techniques are based on the recognition that, when different reference microscope images with varying contrasts are available, alternative options for determining the vector field map are available and thus variance can be tested during the determination.

Optionally, box 1006 could determine a confidence map. Said confidence map may indicate confidence values for the vectors in one or more of the vector field maps from box 1105. The transfection level can then be determined in box 1110 in consideration of the confidence map. For example, an uncertainty could be determined for the transfection level. There are basically different options for determining such a confidence map. For example, multiple vector field maps could be determined on the basis of reference microscope images with different contrasts. For example, a first vector field map could be determined on the basis of a phase contrast microscope image, and a second vector field map could be determined on the basis of a bright-field microscope image. Multiple reference microscope images with different phase contrasts (for example an optical phase contrast and a digital phase contrast) could also be used. This allows different estimates for the vector field map, which estimates can then be compared; based on such a comparison, the confidence can then be determined from a divergence between the two vector field maps. In another variant, a statistical property of vectors in the vector field map could be taken into consideration. For example, a distribution of a length and/or a distribution of the orientation of the vectors in the vector field map could be taken into consideration. The confidence could then be determined on the basis of such a distribution. For example, it would be possible to check whether there is particularly great variation in the length of the vectors. The width of peaks in the distribution could also be taken into consideration. Such techniques are based on the recognition that in typical cell samples the different cells have similar sizes. This is then reflected in a specific distribution of the lengths of the vectors. Based on such prior knowledge for a nominal form of the distribution of the length of the vectors, an applicable divergence can result in a lower confidence being deduced. This can also mean that individual vectors located, for example, in peak margins are assigned a low confidence. Another technique is based on the use of a cell center map. For example, the distances of certain vectors in the vector field map from cell centers shown in the cell center map can be checked. Greater distances can also result in a lower confidence being deduced. Alternatively, or in addition, a cell mask map could be taken into consideration when determining the confidence map. Such a cell mask map can be used to indicate the level of occupancy of different image regions in the microscope images by cells. In that case, the confidence can be determined for example on the basis of a variation in the lengths of the vectors or the divergence of the length of the vectors from a linear value gradient within the cells. In another example, it would be conceivable for the confidence map to be output as another channel directly from an applicable machine-learned model. An applicable prediction of confidence can be learned during the training of the applicable machine-learned model.

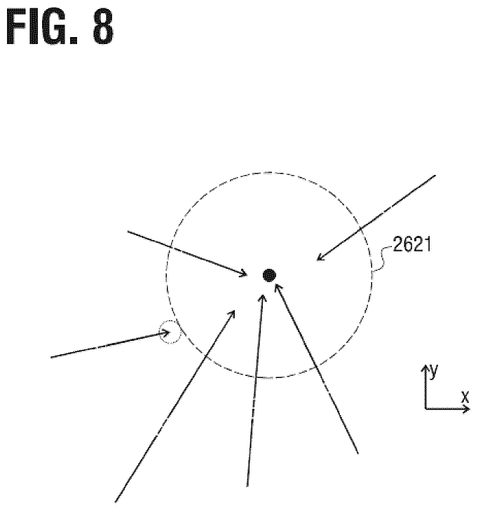

A second image evaluation is carried out in box 1110. This involves the transfection level for each cell in an applicable microscope image being determined. This means that the transfection success is determined for the various cells. This involves the vector field map determined in box 1105 being taken into consideration. An option for the implementation of box 1110 is shown in FIG. 10.

FIG. 10 shows a flowchart for an illustrative method. The method from FIG. 10 is used to evaluate a vector field map that has been predetermined (for example by means of the method from FIG. 2) in order to determine a transfection level for cells in a cell sample. FIG. 10 thus illustrates a method for implementing box 1110 from FIG. 2.

First, the counter values of the counters can be normalized in box 1201 according to the associated image regions. The more image regions are mapped onto a reference image region containing the relevant cell, the larger a corresponding denominator for the normalization, or the normalization factor, could be. For example, the vector field could be applied to a reference image that contains only “1” pixel values. In this way, a counter value is then obtained that corresponds to the number of image regions mapped onto the applicable reference image region by the vector field. The counter value of the reference image regions could then be divided element by element by these reference counters. Thus, each row contains a counter value that corresponds to the average value of the pixel values aggregated there—regardless of the number of vectors pointing to the applicable reference image region and thus regardless of the relevant cell size.

After optional normalization of this kind in box 1201 (the normalization could also be performed later, for example before box 1310, or omitted completely), iterations are performed (iterations 1299) over all image regions that are different in the vector field map—such as pixels or superpixels or other regions: box 1205 selects the current image region for a specific iteration 1299. The respective intensity value, in the current image region, of all pixels of the microscope image that has the decisive fluorescence contrast for the transfection may then be added to a counter value in the relevant reference image region (box 1215). However, in an optional variant, box 1215 is executed only if, beforehand, box 1210 determines that this image region should be taken into consideration. This is because when determining the cell-specific transfection level, it may be helpful to ignore those image regions that cannot be assigned to a cell. This may be implemented in various ways. In the simplest case, one option consists of no signals being present outside of cells in the microscope image with the transfection fluorescence contrast. In this case, a value of 0 is added if the image region contains pixels outside of cells. However, it is sometimes more accurate to explicitly exclude image regions outside of cells from the summation. One option in this respect consists of iterating only over image regions that are located within a given confluency mask. The confluency mask may be determined by means of techniques already known as a matter of principle, for example by means of a machine-learned model. Unlike an instance segmentation mask, such a confluency mask does not have to separate different cell instances. This means that the confluency mask does not segment instances, but merely indicates occupancy by a cell for different image regions. Typically, such a confluency mask can be determined in a particularly robust manner compared to an instance segmentation mask (for example the instance segmentation mask 812 described above with regard to FIG. 9).

Box 1220 then checks whether another image region needs to be taken into consideration in a further iteration 1299 of box 1205. Iterations are performed until all image regions have been processed.

FIG. 10 shows a variant in which the intensity values are added to the counters of the reference image regions iteratively. The addition of the intensity values could be achieved by a matrix multiplication. In this case, a matrix that represents the microscope image may be multiplied by a further matrix that is determined on the basis of the vector field. In different variants, such a matrix multiplication may be implemented once again by an iterative software algorithm. However, it would also be conceivable for the matrix multiplication to be implemented on suitable parallel processor hardware, for example a graphics card—and hence be implemented in hardware-accelerated fashion. The hardware multiplication may thus be hardware-accelerated. This may be helpful for very large images in particular (for instance mosaic images that are composed from a tile scan).

In various examples, the iterations 1299 may be performed multiple times over the image regions that are gradually selected in box 1205. Such an outer loop formed by iterations 1298 is shown with regard to box 1230. Box 1230 checks whether the inner loop of the iterations 1299 should be performed multiple times over the image regions. If this is the case, box 1205 is executed again for the first image region; subsequently, all image regions are then in turn selected in the multiple iterations 1299 that are performed again. Such a technique with multiple performance of the iterations 1299 over all image regions has the advantage that the pixel values for vector field maps in which the vectors form vector chains (cf. FIG. 5) can be gradually shifted along a vector chain. This is based on the recognition that vectors far away from a cell center are often inaccurate and only shift the fluorescence signal close to a cell center. If a further iteration 1298 is performed, then these pixel values can be shifted from a counter farther away from a cell center to a counter closer to the cell center. However, there is a description above, in particular with regard to box 1105.2, of techniques that involve vector chains being able to be prospectively removed from the vector field map by means of a suitable post-processing. This is done by replacing two or more vectors that together form a vector chain with a single vector from the beginning of the first vector in the vector chain to the last vector in the vector chain. In such a scenario, it is typically unnecessary to perform multiple outer loops using the iterations 1298. However, if multiple iterations 1298 are performed, one or more termination criteria can be taken into consideration. For example, the one or more termination criteria could comprise a certain number of iterations 1298. Alternatively or in addition, such a termination criterion could also take into consideration a spatial distribution of the pixel values over the reference image regions. For example, such a spatial distribution could be compared with a particular specification. This thus means, in other words, that for example it is possible to check whether the variation in the counter value of the reference image regions in position space is sufficiently small or whether the counter values are sufficient to assume values not equal to zero in a localized manner. Alternatively or in addition, it would also be possible to look at a change in the distribution of the pixel values over the reference image regions from iteration 1298 to iteration 1298. If this distribution of the counter values over the reference image regions no longer changes or no longer changes significantly from iteration 1298 to iteration 1298, a stable state has been reached: the counter values were also shifted along the longest vector chains of the vector field map to the end.

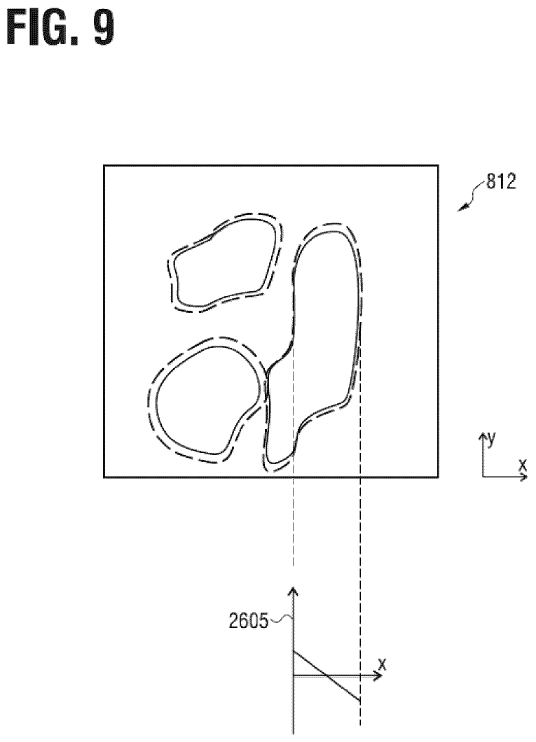

Box 1310 then determines the transfection level. In particular, a cell-specific transfection level can be determined for each cell. For example, this could be accomplished by comparing the counter values of the different reference image regions with a threshold value. If the counter value exceeds this threshold value, transfection can be assumed. If the counter value does not fall below the threshold value, it can be assumed that the applicable cell is non-transfected, i.e. does not express the fluorescent dye. Such a threshold value can be obtained in various ways. For example, the threshold value can be obtained from a user input. It would also be conceivable for a distribution of counter values of the counters of the various reference image regions to be taken into consideration (cf. FIG. 11, which shows such a distribution 2451 of the counter values 2450 of the reference image regions and a relevant threshold value 2452 that separates applicable regularity peaks). This thus means that the regularity of certain counter values for the set of reference image regions can be taken into consideration. The threshold value can then be determined on the basis of this distribution. The threshold value may thus be adaptively adjustable. Another example of the implementation of box 1310 concerns the determination of subregions in the one or more microscope images, these subregions being assigned to different cells. For example, these subregions can be determined on the basis of the vector field map. For example, the subregions can be formed in such a way that all vectors or vector chains pointing to a common point label image regions that are assigned to a common cell. However, it would also be conceivable for a separate instance segmentation to be performed. Then, if the different image regions are assigned to the different cells, a distribution of the pixel values of image pixels can be determined for each of the cells. In other words, this thus means that a distribution of the respective values of the image pixels is obtained per cell. These distributions can then be compared with each other, for example on the basis of a distance measure for distributions, to assign the different cells to transfected cells or non-transfected cells. For example, a cluster analysis could be performed in the space of the distributions of the pixel values of the image pixels for each of the cells (cf. FIG. 12; this shows distributions of the pixel values 2460 relevant to different clusters using dotted and dashed lines). Before the comparison of the distributions is performed, a normalization of the counter value or the distributions could also be carried out, for example according to a number of reference image regions or a percentage number of image pixels or a size of the cell. When comparing distributions, the separation can thus be formed as a (linear) trajectory (cf. FIG. 12: dividing line 2462) by the feature space between the clusters of distributions. This trajectory moves on a hyperplane that is a separation plane between transfected and non-transfected cells. However, the points can also be transferred to a continuum, for example with a main component analysis. In this way, a one-dimensional feature space can be obtained. In another example of the implementation of box 1310, latent feature vectors of the pixel values of the image pixels are determined for each cell and then these latent feature vectors are compared with each other. In other words, this thus means that all cell centers are embedded. The applicable feature vectors can then be compared with each other, for example clusters can be found in the applicable feature space. A straight line or a diversity for the applicable dimension could be fitted in the feature space. Another variant for implementing box 1310 concerns the determination of image patches for each cell. Again, the cells can be localized on the basis of the vector field map, for example, as described above. A machine-learned network can then be used to process these image patches to determine the cell-specific transfection level for each cell. For example, it would be conceivable for a concatenation of the image patches (which, for example, can all have the same resolution) to be passed to the machine-learned network. Then, for example, the transfection level can also be determined on the basis of a comparison of the applicable latent features by means of cross-attention across the various channels. Taking into consideration cross-attention allows such a machine-learned network to also take into consideration features that are based on the same or a different appearance of the transfected and non-transfected cells. In this way, particularly robust separation between transfection and non-transfection can be carried out for the different cells on the basis of the appearance of the different cells in the fluorescence microscope image.

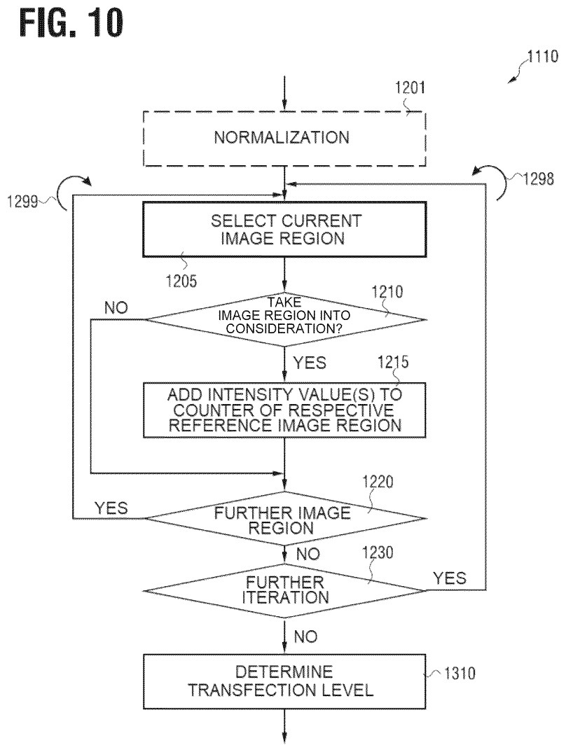

FIG. 13 schematically illustrates an electronic data processing device 700 according to various examples. The electronic data processing device 700 comprises a processor unit 705 and a memory 706. The electronic data processing device also comprises a communications interface 707. For example, the processor unit 705 could receive one or more microscope images (cf. FIG. 1: box 905) from a microscope via the communication interface 707. The processor unit 705 could also send control data to the microscope in order to capture the microscope images (for example using specified imaging parameters or specific imaging modalities and contrasts). In another variant, the processor unit 705 could load the microscope images from the local memory 706. Moreover, the processor 705 is able to load program code from the memory 706 and execute it. When the processor unit 705 executes the program code, the effect is that the processor performs techniques as described herein. For example, the processor unit could perform techniques described with regard to FIG. 1, FIG. 2 and FIG. 10.

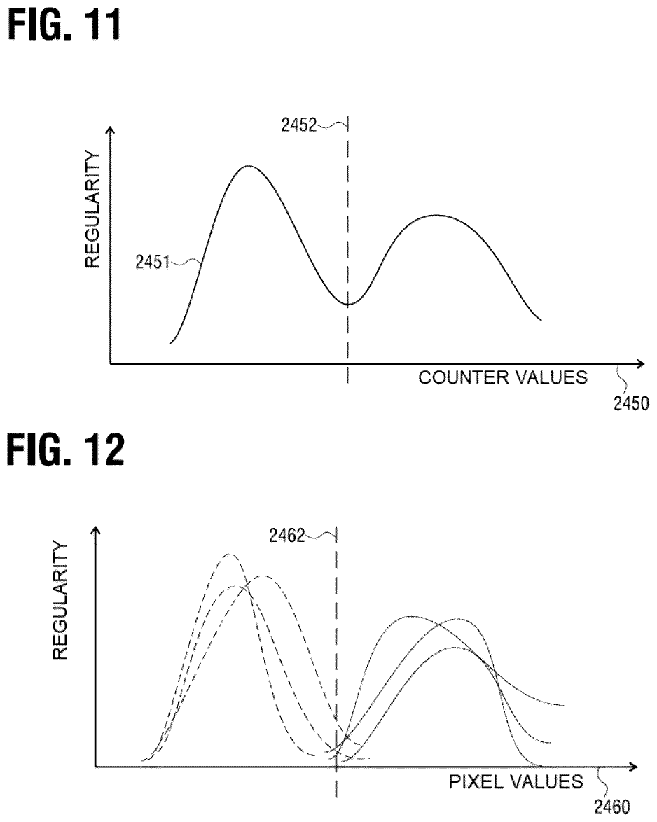

FIG. 14 schematically illustrates a data processing sequence according to various examples. The data processing sequence according to FIG. 14 can be executed by the processor unit 705, for example, on the basis of program code from the memory 706.

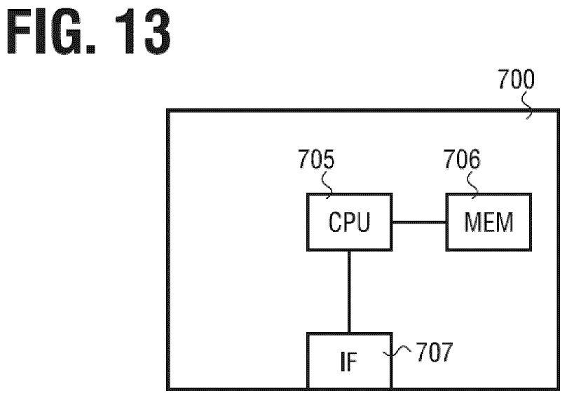

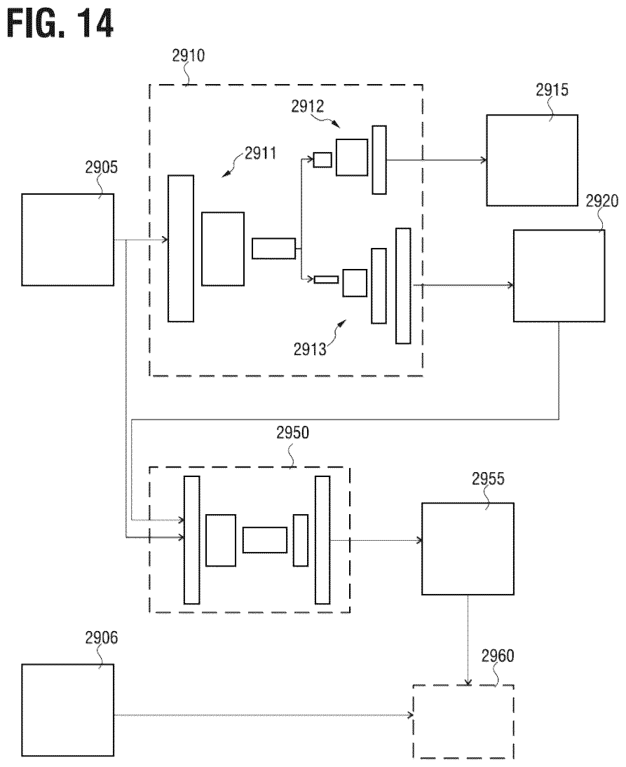

FIG. 14, a phase contrast microscope image 2905 and a fluorescence microscope image 2906 are obtained. Both image a scene with one or more cells. An illustration of the phase contrast microscope image 2905 is also shown in FIG. 15. Referring again to FIG. 14: the phase contrast microscope image 2905 is processed in a machine-learned model 2910. The machine-learned model 2910 comprises a coding branch 2911 and two decoding branches 2912, 2913. The machine-learned model 2910 outputs a cell mask map 2915, typically a confluency map. Moreover, the machine-learned model 2910 also outputs a cell center map 2920. The cell mask map 2915 and/or the cell center map 2920 can also be reused in different ways. For example, it would be conceivable, as described above with regard to FIG. 2: box 1106, to use the maps to determine a confidence map for a vector field. Alternatively, or in addition, such maps can also be used directly to determine the vector field. For example, such maps can be used to check the prediction of a machine-learned model for a vector field for confidence and, where applicable, to correct it locally. For example, a cell mask map can be determined and then a cell-specific transfection level can be determined on the basis of the cell mask map. While FIG. 14 shows a scenario in which the machine-learned model 2910 is jointly trained and has multiple decoding branches 2912, 2913 to determine the cell mask map 2915 and the cell center map 2920, it would also be conceivable, in various examples, for different machine-learned models to be used to determine the cell mask map 2915 and to determine the cell center map 2920. In addition, it would be conceivable for the phase contrast microscope image 2905 to first be rescaled jointly with the fluorescence microscope image 2906 before the phase contrast microscope image 2905 is processed in the machine-learned model 2910 (this is not shown in FIG. 14; it has, however, been discussed above with regard to FIG. 1: box 910). It would also be possible for another image preprocessing—for example as described above with regard to FIG. 1: box 920—to be performed; this is also not shown in FIG. 14. FIG. 16 illustrates the cell center map 2920 for the phase contrast microscope image 2905; FIG. 16 also illustrates the cell center map 2920 overlaid 2921 on the phase contrast microscope image 2905.

Referring again to FIG. 14: although not shown in FIG. 14, it would be conceivable for the cell mask map 2915 to be used to remove or reduce an interference signal component of the fluorescence signal of the fluorescence microscope image 2906. Corresponding techniques were also described above with regard to box 920.

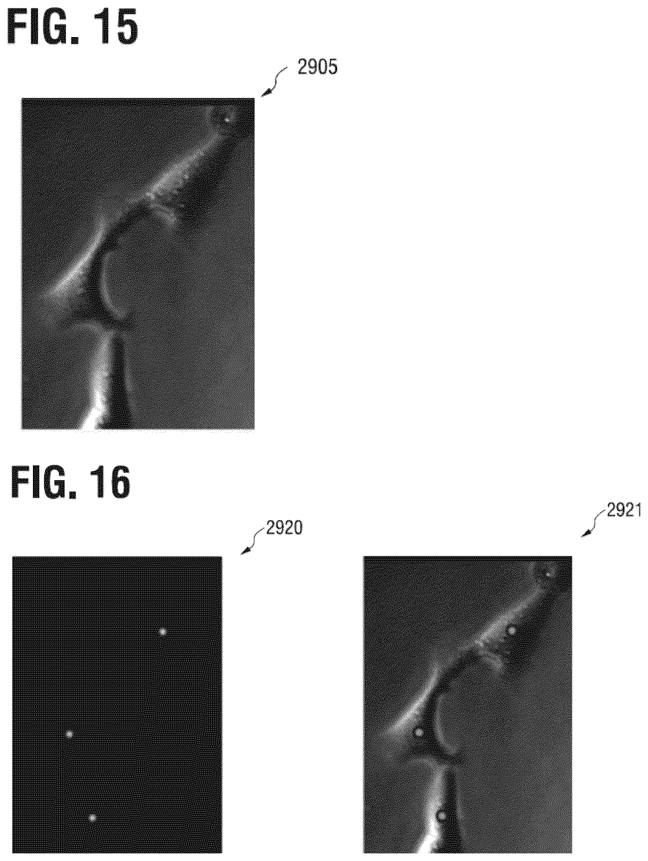

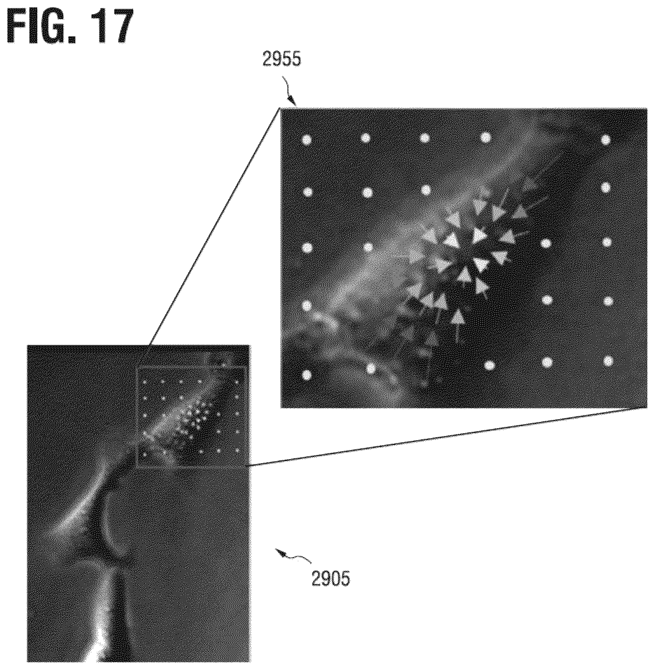

Based on the cell center map 2920 and the phase contrast microscope image 2905, the vector field map 2955 can then be determined in a machine-learned model 2950. Corresponding techniques were described above with regard to box 1105, box 1105.1 and box 1105.2 in FIG. 2. For example, the vector field map can first be determined by means of a machine-learned model and then a consistency check can be performed. Such techniques were described above with regard to FIG. 7 and FIG. 8. Instead of—as shown in FIG. 14—using a machine-learned model to determine the vector field map 2955, it would also be conceivable for an instance segmentation map to be used to determine the vector field map (corresponding techniques were explained above with regard to the linear value gradient 2605 in FIG. 9 or box 1105.3). In some examples, inference can result in a machine-learned model being used to determine the vector field map, as shown in FIG. 14; to generate training data for this machine-learned model, an instance segmentation map is used to generate ground truths for the vector field maps on the basis of phase contrast microscope images in a weakly supervised or unsupervised manner. FIG. 17 shows the phase contrast microscope image 2905 overlaid with the determined vector field map 2955; it can be seen here that the vector field outside of cells is forced to zero, for example on the basis of the cell mask map 2915, which indicates the confluency without segmenting cell instances, i.e. on the basis of a confluency map); within a cell, the vectors point to a common reference image region arranged at or close to an applicable cell center. FIG. 18 shows the vector field map 2955 overlaid on the fluorescence microscope image 2906.

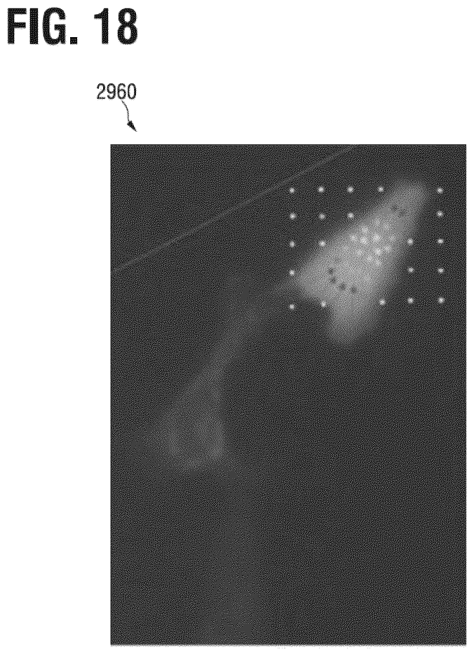

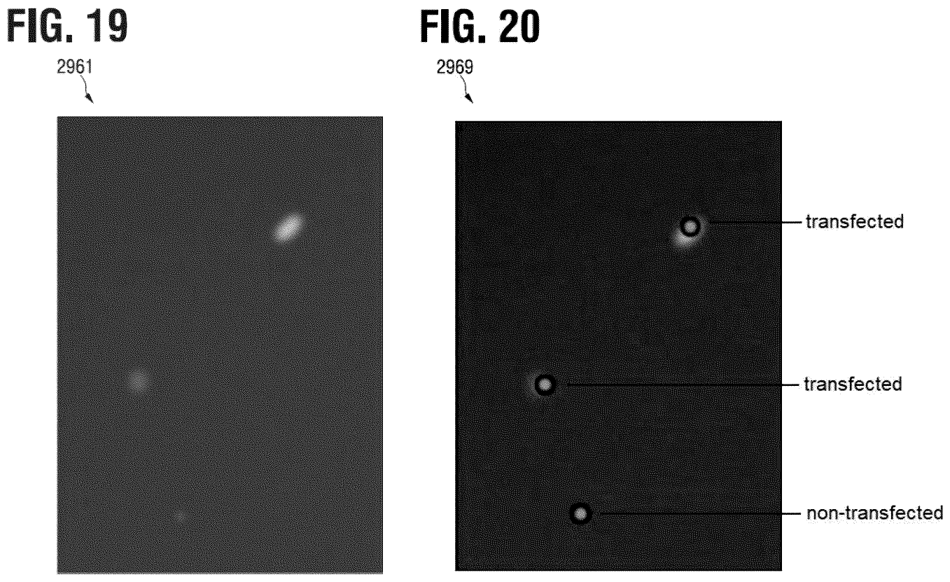

Referring again to FIG. 14: this fluorescence microscope image 2906 (where applicable after the aforementioned background correction and/or a rescaling) is then subsequently processed together with the vector field map 2955 in an algorithm 2960. This algorithm 2960 corresponds to box 1110; this is because the transfection level for each cell is determined there. The algorithm could, for example, be implemented according to FIG. 10. This thus means that values of the fluorescence signal (corresponds to the pixel values of the fluorescence microscope image 2906) are aggregated in applicable cells, for example by applying the vector field to the fluorescence microscope image 2906. For example, an image can be obtained that aggregates the sum of all pixel values belonging to the cell at the cell center in an applicable counter. Such an image 2961 is shown in FIG. 19. The applicable counter values could still be normalized, as described above with regard to FIG. 10: box 1201. Subsequently, binary assignment of cells to a class “transfected cells” or a class “non-transfected cells” can be carried out. For this purpose, the counter value (where applicable normalized, as described above) can be compared with an applicable threshold value. Techniques for determining such a threshold value were already described above with regard to FIG. 11 and FIG. 12. Corresponding assignment of cells to the classes is shown in FIG. 20. FIG. 20 shows the image 2961 (cf. FIG. 19) overlaid 2969 with the cell center map 2920 (cf. FIG. 16); in addition, FIG. 20 shows each of the relevant cells assigned to the class “transfected” and to the class “non-transfected” according to an applicable threshold value. Based on such cell-specific assignment, or such a cell-specific transfection level, a global transfection level can also be determined. For example, a statistic can be generated that indicates what proportion of cells belongs to which of the classes. It is then possible for an applicable result of transfection analysis, for example a visualization at cell level, as shown in FIG. 20, and/or a total statistic to be output to the users. An applicable technique was described above with regard to FIG. 1: box 940.

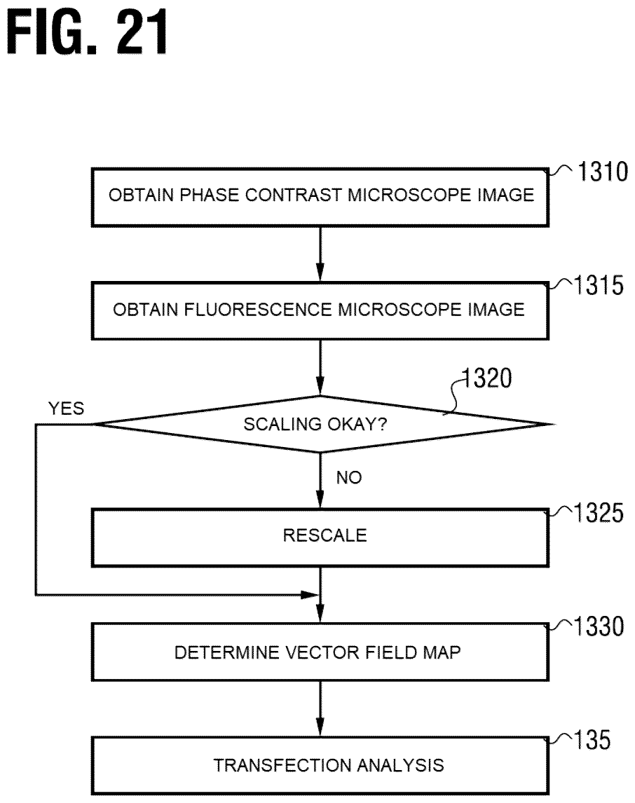

FIG. 21 is a flowchart for an illustrative method. The method from FIG. 21 concerns a computer-implemented transfection analysis. The method from FIG. 21 can implement the data processing sequence from FIG. 16, for example. The method from FIG. 21 can implement the method from FIG. 1, for example.

A phase contrast microscope image is obtained in box 1310. Said phase contrast microscope image images a scene with cells. A fluorescence microscope image is obtained in box 1315. Said fluorescence microscope image has a fluorescence contrast and also images the scene with the cells. For example, box 1310 and box 1315 can thus correspond to box 905. Illustrative phase contrast microscope images and fluorescence microscope images were also described with regard to FIG. 15 (phase contrast microscope image 2905) and FIG. 18 (fluorescence microscope image 2960). The two microscope images from box 1305 and box 1310 may be registered with each other, implicitly or explicitly. If no registration is available, the microscope images can still be registered with each other (not shown; cf. box 910 in FIG. 1).

Subsequently, a check on the scaling of the phase contrast microscope image 1110 or the fluorescence microscope image from box 1315 can be performed in box 1320. On the basis of such a check, box 1325 can optionally be executed; box 1325 rescales the microscope images from box 1305 and box 1310 so that they image the cells according to a structural unit size. This structural unit size can be a size of the cells in training image data used for training one or more machine-learned models (for example for determining a vector field map and/or determining a cell mask map and/or for determining a cell center map). If the scaling is already appropriate, box 1325 can be skipped.

An image evaluation is then performed in box 1330, involving the phase contrast microscope image from box 1310 being taken into consideration. A vector field map is obtained. Aspects with regard to determining a vector field map were described above with regard to FIG. 14 and in particular the machine-learned model 2950. Aspects with regard to alternative algorithms were also described, for example with regard to FIG. 9 and the value gradient 2605. Box 1230 thus corresponds to box 1105 of the method from FIG. 2.

Box 1335 then performs a second image evaluation on the basis of the fluorescence microscope image from box 1315 and the vector field map from box 1330. In this way, cell-specific result data for the scene are obtained that indicate the transfection level for each cell. Applicable aspects were explained in particular with regard to FIG. 18, FIG. 19, FIG. 20 and FIG. 10. FIG. 10 described, for example, how multiple iterations 1299 are executed over image regions so that counter values associated with reference image regions aggregate the pixel values of individual image regions. Such counter values can subsequently be compared with one or more threshold values. In this way, it is possible to determine whether a particular cell is transfected or non-transfected (cf. FIG. 20).

FIG. 22 is a flowchart for an illustrative method. FIG. 22 concerns the separation of an inference phase in box 1810—in which one or more machine-learned models are used with regard to a transfection analysis, as described for example with regard to FIG. 1 and FIG. 21 or described with regard to the data processing sequence in FIG. 14—and a training phase in box 1805. The training phase in box 1805 concerns the training of such machine-learned models.

For example, such machine-learned models can be used to determine a vector field map (cf. FIG. 14: machine-learned model 2950). A phase contrast microscope image can be used as the input. Optionally, additional information can also be used to determine the vector field map, for example a cell center map (to set the reference image regions) and/or a cell mask map, such as in particular a confluency map (to force vector lengths outside of cells to zero). Such a cell mask map and/or cell center map can also be determined using an applicable machine-learned model, which can be trained in box 1805 (FIG. 14: machine-learned model 2910).

Training is carried out in box 1805 on the basis of training data. These training data include applicable pairs of inputs and outputs. For example, training could specifically involve the use of instance segmentation masks determined for example on the basis of a mask convolution network (mask RCNN). Such instance segmentation masks can then be converted into a vector field map (as described with regard to box 1105.3—albeit there for inference). In particular, it is possible, as part of the training in box 1805, to determine ground truths for a vector field map on the basis of such instance segmentation masks by taking linear value gradients defined within the cell instance as a basis for determining the vectors in the vector field map in such a way that they are consistent within each cell and all point to the cell center. In this way, a vector field map can thus be obtained as ground truth for the desired output from the machine-learned model in order to generate vector field maps on the basis of phase contrast microscope images for training this model in box 1805. Since no manual annotation is required, box 1805 can then also be referred to as weakly supervised or unsupervised training for the image-to-vector field map model. This can involve, for example, cell mask maps also being generated automatically using Dijkstra's algorithm, which applies phase contrast microscope images. In the inference phase in box 1810, there is then no need to use instance segmentation maps.

In some variants it is conceivable for feedback from box 1810 to box 1805 to be used. This is illustrated in FIG. 22 by the dashed arrow. For example, a user interaction with regard to the display of a result of transfection analysis (applicable techniques were described above with regard to FIG. 1: box 940 and box 945) can be taken as a basis for obtaining further ground truths and using them for re-training one or more machine-learned models.

In summary, techniques allowing automated determination of the transfection level or transfection rate using image analysis were described above. Thus, the cells in a sample or the number of cells in a sample that express a specific protein as desired are or is determined.

Techniques were described that in general relate to the determination of a cell-specific transfection level of cells imaged using a microscope. Such a cell-specific transfection level may be determined by using at least one machine-learned model that processes one or more microscope images. This is an alternative to manual evaluation of the images, as performed in the prior art.

The microscope images are recorded with different contrasts, e.g. with phase contrast and fluorescence contrast. The phase contrast images typically show all cells equally, regardless of whether or not they are transfected. Conversely, the fluorescence contrast images only show cells that were transfected.

A vector field map may be used in order to determine the transfection level. A vector field map assigns each pixel in the image to a reference region or reference location, e.g. the center of a cell.

The ascertained cell-specific transfection level may then be displayed together with one or more microscope images. Transfected and non-transfected cells may be highlighted in this display, for example using different colors.

In addition to the display of the transfection level for individual cells, it is also possible to determine a scene-global transfection level, which indicates the percentage of all transfected cells in the image.

Summarizing, at least the following CLAUSES have been disclosed.

CLAUSE 1. A computer-implemented method, comprising:
obtaining one or more microscope images that image a scene with cells,
performing a first image evaluation (1105) on the basis of at least one of the one or more microscope images in order to obtain a vector field map (815, 816, 817, 818) that maps each of multiple image regions onto an applicable reference image region, the reference image regions being associated with different cells, and
performing a second image evaluation (1110) on the basis of at least one of the one or more microscope images and the vector field map (815, 816, 817, 818) in order to obtain cell-specific result data for the scene,
   the cell-specific result data indicating a cell-specific transfection level for a fluorescent dye-based transfection of the cells.

CLAUSE 2. The computer-implemented method as described in CLAUSE 1, wherein the second image evaluation comprises iterating (1299) over the image regions, each iteration (1299) involving one or more pixel values of the at least one of the one or more microscope images in the respective image region being added to a counter associated with the relevant reference image region.

CLAUSE 3. The computer-implemented method as described in CLAUSE 2, wherein at least some vectors in the vector field map form vector chains,
the iterating (1299) over the image regions being performed multiple times (1298) so that pixel values are gradually shifted along a vector chain.

CLAUSE 4. The computer-implemented method as described in CLAUSE 3, the iterating over the image regions being performed multiple times until a termination criterion (1230) is met.

CLAUSE 5. The computer-implemented method as described in CLAUSE 4, wherein the termination criterion (1230) is met if a distribution of the pixel values over the reference image regions meets an applicable specification.

CLAUSE 6. The computer-implemented method as described in CLAUSE 4 or 5,
wherein the termination criterion (1230) is met if a change in the distribution of the pixel values over the reference image regions from iteration to iteration is less than a specification.

CLAUSE 7. the computer-implemented method as described in one of CLAUSES 2 to 6,
wherein the second image evaluation furthermore comprises comparing (1310) counter values of the counters of the various reference image regions with a threshold value (2452) in order to determine the cell-specific transfection level.

CLAUSE 8. The computer-implemented method as described in CLAUSE 7, wherein the second image evaluation furthermore comprises determining a distribution (2451) of counter values (2450) of the counters of the various reference image regions, the threshold value (2452) being determined on the basis of the distribution.

CLAUSE 9. The computer-implemented method as described in one of CLAUSES 2 to 8,
wherein the second image evaluation furthermore comprises determining subregions of the at least one of the one or more microscope images assigned to cells, for example on the basis of the vector field map,
the second image evaluation furthermore comprising determining distributions of the pixel values of image pixels for each of the cells,
the second image evaluation furthermore comprising comparing the distributions of the pixel values to determine the cell-specific transfection level.

CLAUSE 10. The computer-implemented method as described in one of CLAUSES 2 to 9, wherein the second image evaluation (1110) furthermore comprises normalizing (1201) the counter values of the counters according to the particular associated image regions.

CLAUSE 11. The computer-implemented method as described in one of CLAUSES 2 to 10,
wherein the second image evaluation furthermore comprises determining subregions of the at least one of the one or more microscope images assigned to cells, for example on the basis of the vector field map,
the second image evaluation furthermore comprising determining latent feature vectors of the pixel values of image pixels for each of the cells,
the second image evaluation furthermore comprising comparing the latent feature vectors to determine the cell-specific transfection level.

CLAUSE 12. The computer-implemented method as described in one of CLAUSES 2 to 10,
wherein the second image evaluation furthermore comprises determining subregions of the at least one of the one or more microscope images assigned to cells, for example on the basis of the vector field map,
the second image evaluation furthermore comprising determining image patches for each of the cells,
a machine-learned network being used to take the image patches as a basis for determining the cell-specific transfection level.

CLAUSE 13. The computer-implemented method as described in one of the preceding CLAUSES,
wherein the second image evaluation comprises a matrix multiplication.

CLAUSE 14. The computer-implemented method as described in one of the preceding CLAUSES, the method furthermore comprising:
configuring at least one of the first image evaluation, the second image evaluation or an image preprocessing according to a type of contrast of at least one of the microscope images.

CLAUSE 15. the computer-implemented method as described in one of the preceding CLAUSES,
wherein the vector field map is determined by means of a machine-learned model (1105.1) of the first image evaluation that performs an image-to-image transformation.

CLAUSE 16. A computer-implemented method for training the machine-learned model of the first image evaluation as described in CLAUSE 15, the method comprising:
determining instance segmentation maps for each of multiple training images,
determining vector field maps on the basis of the instance segmentation maps so that vectors for each cell point to a common applicable point in the cell, and
using the vector field maps in an unsupervised or weakly supervised manner as a ground truth for training the machine-learned model.

CLAUSE 17. The computer-implemented method as described in one of the preceding CLAUSES,
wherein performing the first image evaluation comprises determining (1105.3) a different-cell-segmenting instance segmentation map (812) for the applicable microscope image, and also determining the vectors in the vector field map for each instance of the instance segmentation map on the basis of a linear value gradient (2605) defined between the edges of each cell.

CLAUSE 18. The computer-implemented method as described in one of the preceding CLAUSES,
wherein the first image evaluation determines the vector field map in consideration of at least one boundary condition.

CLAUSE 19. The computer-implemented method as described in CLAUSE 18, wherein the at least one boundary condition comprises a specification for a spatial distance between the reference image regions assigned to adjacent vectors in the vector field map.

CLAUSE 20. The computer-implemented method as described in CLAUSE 18 or 19,
wherein the at least one boundary condition comprises a specification for a distance (2621) between the reference image regions and cell centers shown in a cell center map.

CLAUSE 21. The computer-implemented method as described in one of CLAUSES 18 to 20,
wherein the at least one boundary condition comprises a specification for a length difference between adjacent vectors in the vector field map.

CLAUSE 22. The computer-implemented method as described in one of CLAUSES 18 to 21,
wherein the at least one boundary condition either prohibits or allows vectors in the vector map depending on the subregion of a cell in which the respective vector starts and/or ends.

CLAUSE 23. The computer-implemented method as described in one of CLAUSES 18 to 22,
wherein the at least one boundary condition from the first image evaluation is not taken into consideration in cell edge regions of cells,
the cell edge regions optionally being determined on the basis of a cell mask map.

CLAUSE 24. The computer-implemented method as described in one of CLAUSES 18 to 23, the method furthermore comprising:
selecting the at least one boundary condition according to a contrast type of at least one of the one or more microscope images.

CLAUSE 25. The computer-implemented method as described in one of CLAUSES 18 to 24, the method furthermore comprising:
in the event of noncompliance with the at least one boundary condition: replacing an applicable vector in the vector field map on the basis of one or more adjacent vectors in the vector field map.

CLAUSE 26. The computer-implemented method as described in one of the preceding CLAUSES, the method furthermore comprising:
consolidating reference image regions in the vector field map on the basis of neighborhood relationships between the reference image regions.

CLAUSE 27. The computer-implemented method as described in one of the preceding CLAUSES, the method furthermore comprising:
determining (1106) a confidence map that indicates confidence values for vectors in the vector field map,
   the second image evaluation furthermore being performed on the basis of the confidence map.

CLAUSE 28. The computer-implemented method as described in CLAUSE 27, wherein the confidence map is determined on the basis of a comparison between the vector field map and another vector field map determined on the basis of another of the one or more microscope images.

CLAUSE 29. The computer-implemented method as described in CLAUSE 28, wherein the at least one microscope image associated with the vector field map and the at least one other microscope image associated with the other vector field map have different contrasts.

CLAUSE 30. The computer-implemented method as described in one of CLAUSES 27 to 29,
wherein the confidence map is determined on the basis of a distribution of a length and/or orientation of the vectors in the vector field map and/or on the basis of a distance of the reference image regions from cell centers shown in a cell center map and/or from a cell mask map.

CLAUSE 31. The computer-implemented method as described in one of the preceding CLAUSES, the method furthermore comprising:
determining a cell mask map,
   the second image evaluation furthermore being performed on the basis of the cell mask map.

CLAUSE 32. The computer-implemented method as described in one of the preceding CLAUSES,
wherein the at least one of the one or more microscope images that is evaluated as part of the second image evaluation comprises a first microscope image with a fluorescence contrast specific to the fluorescent dye and optionally a second microscope image, the second microscope image having a contrast that specifically labels cell structures of the cells that correspond to the reference image regions.

CLAUSE 33. The computer-implemented method as described in one of the preceding CLAUSES,
wherein the first image evaluation and the second image evaluation are performed by a jointly machine-learned model.

CLAUSE 34. The computer-implemented method as described in one of the preceding CLAUSES,
wherein the one or more microscope images comprise multiple sectional images associated with different surfaces by a three-dimensional volume of the scene with the cells,
the second image evaluation combining the vector field map with at least one other vector field map, the vector field map and each of the at least one other vector field map being associated with the different sectional planes.

CLAUSE 35. The computer-implemented method as described in one of the preceding CLAUSES, the method furthermore comprising:
converting the vector field map into an instance segmentation map, and
displaying (940) the instance segmentation map.

CLAUSE 36. The computer-implemented method as described in one of the preceding CLAUSES, the method furthermore comprising:
performing (915, 920) at least one from a smoothing operation, a noise removal operation, or a rescaling of the one or more microscope images before the first image evaluation is performed and the second image evaluation is performed.

CLAUSE 37. The computer-implemented method as described in one of the preceding CLAUSES, the method furthermore comprising:
determining a first distribution of pixel values of image pixels assigned to transfected cells on the basis of the cell-specific transfection level, and
determining a second distribution of pixel values of image pixels assigned to non-transfected cells on the basis of the cell-specific transfection level, and
displaying at least one of the first distribution or the second distribution.

CLAUSE 38. The computer-implemented method as described in one of the preceding CLAUSES, the method furthermore comprising:
displaying (940) at least one of the one or more microscope images overlaid with a cell-specific graphical indicator of the cell-specific transfection level.

CLAUSE 39. A computer-implemented method, comprising:
obtaining a microscope image with phase contrast that images a scene with cells,
obtaining a microscope image with fluorescence contrast that images a scene with cells,
checking a scaling of the microscope image with phase contrast and the microscope image with fluorescence contrast and, on the basis of the checking, optionally changing the scaling,
performing an image evaluation on the basis of the microscope image with phase contrast in order to obtain a vector field map that maps each of multiple image regions onto an applicable reference image region, the reference image regions being associated with different cells,
performing a second image evaluation on the basis of the microscope image with fluorescence contrast and the vector field map in order to obtain cell-specific result data for the scene, the cell-specific result data indicating a cell-specific transfection level for a transfection of the cells that is based on a fluorescent dye,
   wherein the second image evaluation comprises iterating over the image regions, each iteration involving one or more pixel values of the at least one of the one or more microscope images in the respective image region being added to a counter associated with the relevant reference image region,
   wherein the second image evaluation furthermore comprises comparing counter values of the counters of the various reference image regions with a threshold value in order to determine the cell-specific transfection level.

CLAUSE 40. An electronic data processing device, comprising a processor unit (705) designed to carry out a method as described in one of the preceding CLAUSES.

It goes without saying that the features of the embodiments and aspects of the invention described above can be combined with one another. In particular, the features can be used not only in the combinations described but also in other combinations or on their own, without departing from the scope of the invention.

For example, various techniques were described above with regard to 2-D microscope images. However, the various techniques described herein may also be used with regard to 3-D microscope images.

Moreover, various techniques in which multiple microscope images with different contrasts are used to determine result data were described above. However, the various techniques described herein may also be determined on the basis of, for example, a single microscope image, for example with an autofluorescence contrast.

Furthermore, techniques in which the first image evaluation for determining the vector field map and the second image evaluation for determining a transfection level are implemented separately, for example by separate algorithms, were described above. It would also be conceivable, however, for a common machine-learned model to be used that is trained end to end and determines both the vector field map and the transfection level. It would also be conceivable for one or more preprocessing steps to be taken into consideration in such an end-to-end machine-learned model, for example a rescaling of the input image to a structural standard size. Such a machine-learned model could also determine a cell center map, with for example different decoding branches mapping from a common feature space to determine firstly the vector field map and secondly the cell center map. Multiple decoding branches could also be used to determine firstly the vector field map and secondly (as an alternative or in addition to a cell center map) a cell mask map. Such a cell mask map may, for example, be in the form of a confluency mask or foreground mask or may also separate cell instances from each other, that is to say may be in the form of an instance segmentation map. Such a cell mask map can be used to amend vectors in a vector field map (for example as explained above with regard to FIG. 7 and FIG. 8). Alternatively, or in addition, such a cell mask map could be used to determine the confidence of the vector field map.

Furthermore, there is a description above of techniques that involve two-dimensional vector field maps being determined for two-dimensional microscope images. Such two-dimensional microscope images can be sectional images that are extracted along surfaces (for example planes) from a three-dimensional volumetric imaging data set. Different volumetric imaging modalities are known that provide a volumetric microscopy image data set. Examples include laser scanning microscopy, light-sheet microscopy, two-photon microscopy, wide-field microscopy, light-field microscopy or spinning disc microscopy. The same techniques described herein can then be applied to each sectional image; it is then conceivable for the two-dimensional vector field maps to be merged into a three-dimensional vector field map. It would also be conceivable for cell-specific result data to be determined for each sectional image; and then for these two-dimensional cell-specific result data to be merged to obtain three-dimensional cell-specific result data in the imaging volume. When merging the two-dimensional vector field maps, it may be taken into consideration that vectors in different vector field maps (associated with different sectional images) may have end points that nominally designate the same cell, but—due to the different associated surfaces—end at different three-dimensional coordinates in the reference coordinate system of the imaging volume. This circumstance can be taken into consideration for a consolidation that, for example, draws on prior knowledge with regard to the arrangement of the various surfaces or on prior knowledge with regard to the expansion of the cells.

1. A computer-implemented method, comprising:
obtaining one or more microscope images that image a scene with cells,
performing a first image evaluation on the basis of at least one of the one or more microscope images in order to obtain a vector field map that maps each of multiple image regions onto an applicable reference image region, the reference image regions being associated with different cells, and
performing a second image evaluation on the basis of at least one of the one or more microscope images and the vector field map in order to obtain cell-specific result data for the scene,
the cell-specific result data indicating a cell-specific transfection level for a fluorescent dye-based transfection of the cells.

2. The computer-implemented method as claimed in claim 1, wherein the second image evaluation comprises iterating over the image regions, each iteration comprising one or more pixel values of the at least one of the one or more microscope images in the respective image region being added to a counter associated with the relevant reference image region.

3. The computer-implemented method as claimed in claim 2,
wherein at least some vectors in the vector field map form vector chains, the iterating over the image regions being performed multiple times so that pixel values are gradually shifted along a vector chain.

4. The computer-implemented method as claimed in claim 3, the iterating over the image regions being performed multiple times until a termination criterion is met,
wherein the termination criterion is met if a distribution of the pixel values over the reference image regions meets an applicable specification, and/or if a change in the distribution of the pixel values over the reference image regions from iteration to iteration is less than a specification.

5. (canceled)

6. (canceled)

7. The computer-implemented method as claimed in claim 2,
wherein the second image evaluation furthermore comprises one or more of: (i) comparing counter values of the counters of the various reference image regions with a threshold value in order to determine the cell-specific transfection level, (ii) determining subregions of the at least one of the one or more microscope images assigned to cells, determining distributions of the pixel values of image pixels for each of the cells, and comparing the distributions of the pixel values to determine the cell-specific transfection level; and/or (iii) normalizing the counter values of the counters according to the particular associated image regions.

8. (canceled)

9. (canceled)

10. (canceled)

11. The computer-implemented method as claimed in claim 2,
wherein the second image evaluation furthermore comprises determining subregions of the at least one of the one or more microscope images assigned to cells, for example on the basis of the vector field map,
the second image evaluation furthermore comprising determining latent feature vectors of the pixel values of image pixels for each of the cells,
the second image evaluation furthermore comprising comparing the latent feature vectors to determine the cell-specific transfection level.

12. The computer-implemented method as claimed in claim 2,
wherein the second image evaluation furthermore comprises determining subregions of the at least one of the one or more microscope images assigned to cells, for example on the basis of the vector field map,
the second image evaluation furthermore comprising determining image patches for each of the cells,
a machine-learned network being used to take the image patches as a basis for determining the cell-specific transfection level.

13. The computer-implemented method as claimed in claim 1,
wherein the second image evaluation comprises a matrix multiplication.

14. The computer-implemented method as claimed in claim 1, the method furthermore comprising:
configuring at least one of the first image evaluation, the second image evaluation or an image preprocessing according to a type of contrast of at least one of the microscope images.

15. The computer-implemented method as claimed in claim 1,
wherein the vector field map is determined by means of a machine-learned model of the first image evaluation that performs an image-to-image transformation.

16. A computer-implemented method for training the machine-learned model of the first image evaluation as claimed in claim 15, the method comprising:
determining instance segmentation maps for each of multiple training images,
determining vector field maps on the basis of the instance segmentation maps so that vectors for each cell point to a common applicable point in the cell, and
using the vector field maps in an unsupervised or weakly supervised manner as a ground truth for training the machine-learned model.

17. The computer-implemented method as claimed in claim 1,
wherein performing the first image evaluation comprises determining a different-cell-segmenting instance segmentation map for the applicable microscope image, and also determining the vectors in the vector field map for each instance of the instance segmentation map on the basis of a linear value gradient defined between the edges of each cell.

18. The computer-implemented method as claimed in claim 1,
wherein the first image evaluation determines the vector field map in consideration of at least one boundary condition; y
wherein the at least one boundary condition comprises at least one of (i) a target specification for a spatial distance between the reference image regions assigned to adjacent vectors in the vector field map; (ii) a target specification for a distance between the reference image regions and cell centers shown in a cell center map; or (iii) a target specification for a length difference between adjacent vectors in the vector field map.

19. (canceled)

20. (canceled)

21. (canceled)

22. The computer-implemented method as claimed in claim 18,
wherein the at least one boundary condition either prohibits or allows vectors in the vector map depending on the subregion of a cell in which the respective vector starts and/or ends.

23. The computer-implemented method as claimed in claim 18,
wherein the at least one boundary condition is not taken into consideration by the first image evaluation in cell edge regions of cells,
the cell edge regions optionally being determined on the basis of a cell mask map.

24. The computer-implemented method as claimed in claim 18, the method furthermore comprising:
selecting the at least one boundary condition according to a contrast type of at least one of the one or more microscope images.

25. The computer-implemented method as claimed in claim 18, the method furthermore comprising:
in the event of noncompliance with the at least one boundary condition: replacing an applicable vector in the vector field map on the basis of one or more adjacent vectors in the vector field map.

26. The computer-implemented method as claimed in claim 1, the method furthermore comprising:
consolidating reference image regions in the vector field map on the basis of neighborhood relationships between the reference image regions.

27. The computer-implemented method as claimed in claim 1, the method furthermore comprising:
determining a confidence map that indicates confidence values for vectors in the vector field map,
the second image evaluation furthermore being performed on the basis of the confidence map.

28. The computer-implemented method as claimed in claim 27, wherein the confidence map is determined on the basis of one or more of the following: (i) a comparison between the vector field map and another vector field map determined on the basis of a different one of the one or more microscope images; (ii) a distribution of a length and/or orientation of the vectors in the vector field map; or (iii) and/or on the basis of a distance of the reference image regions from cell centers shown in a cell center map and/or from a cell mask map.

29. (canceled)

30. (canceled)

31. The computer-implemented method as claimed in claim 1, the method furthermore comprising:
determining a cell mask map,
the second image evaluation furthermore being performed on the basis of the cell mask map.

32. The computer-implemented method as claimed in claim 1,
wherein the at least one of the one or more microscope images that is evaluated as part of the second image evaluation comprises a first microscope image with a fluorescence contrast specific to the fluorescent dye and optionally a second microscope image, the second microscope image having a contrast that specifically labels cell structures of the cells that correspond to the reference image regions.

33. (canceled)

34. The computer-implemented method as claimed in claim 1,
wherein the one or more microscope images comprise multiple sectional images associated with different surfaces by a three-dimensional volume of the scene with the cells,
the second image evaluation combining the vector field map with at least one other vector field map, the vector field map and each of the at least one other vector field map being associated with the different sectional planes.

35. (canceled)

36. (canceled)

37. The computer-implemented method as claimed in claim 1, the method furthermore comprising:
determining a first distribution of pixel values of image pixels assigned to transfected cells on the basis of the cell-specific transfection level, and
determining a second distribution of pixel values of image pixels assigned to non-transfected cells on the basis of the cell-specific transfection level, and
displaying at least one of the first distribution or the second distribution.

38. The computer-implemented method as claimed in claim 1, the method furthermore comprising:
displaying at least one of the one or more microscope images overlaid with a cell-specific graphical indicator of the cell-specific transfection level.

39. A computer-implemented method, comprising:
obtaining a microscope image with phase contrast that images a scene with cells,
obtaining a microscope image with fluorescence contrast that images a scene with cells,
checking a scaling of the microscope image with phase contrast and the microscope image with fluorescence contrast and, on the basis of the checking, optionally changing the scaling,
performing an image evaluation on the basis of the microscope image with phase contrast in order to obtain a vector field map that maps each of multiple image regions onto an applicable reference image region, the reference image regions being associated with different cells,
performing a second image evaluation on the basis of the microscope image with fluorescence contrast and the vector field map in order to obtain cell-specific result data for the scene, the cell-specific result data indicating a cell-specific transfection level for a transfection of the cells that is based on a fluorescent dye,
wherein the second image evaluation comprises iterating over the image regions,
each iteration involving one or more pixel values of the at least one of the one or more microscope images in the respective image region being added to a counter associated with the relevant reference image region,
wherein the second image evaluation furthermore comprises comparing counter values of the counters of the various reference image regions with a threshold value in order to determine the cell-specific transfection level.

40. An electronic data processing device, comprising a processor unit configured to:
obtain one or more microscope images that image a scene with cells,
perform a first image evaluation on the basis of at least one of the one or more microscope images in order to obtain a vector field map that maps each of multiple image regions onto an applicable reference image region. the reference image regions being associated with different cells, and
perform a second image evaluation on the basis of at least one of the one or more microscope images and the vector field map in order to obtain cell-specific result data for the scene.
the cell-specific result data indicating a cell-specific transfection level for a fluorescent dye-based transfection of the cells.
